(19) United States
(12) Patent Application Publication
(10) Pub. No.: US 2007/0094333 A1
(43) Pub. Date: Apr. 26, 2007

(54) Video e-mail system with prompter and subtitle text

(76) Inventors: Jeffrey C. Schilling, Joplin, MO (US); James I. Pendergraft, Seneca, MO (US)

Correspondence Address: MARTIN & ASSOCIATES, LLC, P O BOX 548, CARTHAGE, MO, 64836-0548, US

(21) Appl. No.: 11/255,041

(22) Filed: Oct. 20, 2005

(51) Int. Cl. G06F 15/16

(52) U.S. Cl. 709/206

(57) ABSTRACT

A video e-mail system eliminates the distribution of a video file to each recipient of a video e-mail by receiving a video e-mail designated for multiple recipients, storing the corresponding video file, creating a link to the corresponding video file in the e-mail, and sending the e-mail that includes the link to each of the designated recipients. The video e-mail system also includes a text prompter that displays the contents of a text file as a script for a user to read when recording a video message. The text file may be used to generate a text subtitle file that is stored with the corresponding video file. When the user clicks on the link in the e-mail corresponding to the video file, the video file is played with the subtitle text that was generated from the text prompt file.

### BACKGROUND OF THE INVENTION

1. Technical Field

This invention generally relates to computer systems, and more specifically relates to e-mail systems.

2. Background Art

Video prompters have been used for decades to provide text for both live television broadcasts and for the recording of videos. For example, most televisions stations that include news programs have video prompters that provide the text that the news anchors read during a live news broadcast. The video prompters are typically located next to a camera to give the impression that the news anchor is looking in the camera while talking. In reality, the news anchor is simply reading the text from a video prompter monitor next to the camera.

Subtitle (or closed caption) text has been provide for a number of different programs. Providing subtitle text for a live television broadcast requires a human typist to enter the text of the people speaking as they speak. This introduces a delay between the audio feed and the close captioning that makes viewing less pleasing. For recorded programs, the subtitle text may be inserted by suitable processing after the program is recorded. Thus, a human operator may listen to the audio portion of the program, type in the corresponding subtitle text, and perform some action to synchronize the subtitles to the audio. If course, other tools may be used to generate subtitle text, including speech recognition processors that generate a text stream from the audio portion of the program. Most speech recognition processors will not accurately transcribe all words, which means it is typically a manual process to go through the automatically generated subtitle text and check the transcription for errors and missed words, and to replace the errors or missed words with the right words. This process is very time-consuming.

Video e-mails are gaining in popularity, especially with the widespread acceptance and use of small cameras known as webcams on personal computer systems. A webcam is typically placed on top of the user's computer monitor. Using a webcam, a person can record a video message, then send the message to a number of specified recipients. The problem with this approach is the relatively large size of video files. If a person records a video message that results in a video file of several megabytes in size, sending this message to a large number of recipients results in the large video file being replicated and send individually to each recipient. Some people have e-mail servers that do not allow attachments that exceed some specified size. If the video file attachment is larger than the specified size, the recipient will not receive the video file.

In addition, current solutions to providing subtitle text for a video file created by a user using a webcam require the user to manually enter the text for the text subtitle file. This process is time-consuming and inefficient. Without a more efficient way to distribute video e-mail messages that include subtitle text that is efficiently generated, the computer industry will continue to suffer from inefficient methods for sending video e-mail messages that include subtitle text to multiple people.

### DISCLOSURE OF INVENTION

According to the preferred embodiments, a video e-mail system eliminates the distribution of a video file to each recipient of a video e-mail by receiving a video e-mail designated for multiple recipients, storing the corresponding video file, creating a link to the corresponding video file in the e-mail, and sending the e-mail that includes the link to each of the designated recipients. When the recipient reads the e-mail, the recipient may click on the link, which causes the video to be downloaded and played for the user. The video e-mail system of the preferred embodiments also includes a text prompter that displays the contents of a text file as a script for a user to read when recording a video message. The text file may be used to generate a text subtitle file that is stored with the corresponding video file. When the user clicks on the link in the e-mail corresponding to the video file, the video file is played with the subtitle text. The preferred embodiments thus use a text prompt file to generate the text subtitle file, resulting in an end-to-end system that very efficiently creates subtitle text for a video that is recorded by a user.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a video e-mail system in accordance with the preferred embodiments;

FIG. 2 is a block diagram of a prior art system for sending a video e-mail to multiple recipients;

FIG. 3 is a flow diagram of a prior art method for creating and sending a video e-mail using the system shown in FIG. 2;

FIG. 4 is a block diagram of a system for sending a video e-mail to multiple recipients in accordance with the preferred embodiments;

FIG. 5 is a flow diagram of a method for creating and sending a video e-mail in accordance with the preferred embodiments using the system shown in FIG. 4;

FIG. 6 is a display window showing e-mail settings a user may specify to generate a video e-mail in accordance with the preferred embodiments;

FIG. 7 is a display window showing general settings a user may specify to generate a video e-mail in accordance with the preferred embodiments;

FIG. 8 is a display window showing video settings a user may specify to generate a video e-mail in accordance with the preferred embodiments;

FIG. 9 is a display window showing text in a text file that may be used to prompt a user when recording a video file;

FIG. 10 is a display window showing how the text file may be displayed as text prompts to a user while recording a video file in accordance with the preferred embodiments;

FIG. 11 is display window showing a time-indexed file that is generated from the text file that was used for text prompts in accordance with the preferred embodiments;

FIG. 12 is a display window showing a closed caption file that is generated from the time-indexed file in FIG. 11 in accordance with the preferred embodiments;

FIG. 13 is a display window showing a second e-mail that includes a link to a video file stored on a video e-mail server, where the second e-mail was generated by the video e-mail server from a first e-mail that was sent to the video e-mail server;

FIG. 14 is a display window showing a web page that includes a video player that plays the video file corresponding to the link in FIG. 13 with corresponding closed caption text;

FIG. 15 is a flow diagram of a method in accordance with the preferred embodiments;

FIG. 16 is a flow diagram of a method for doing business in accordance with the preferred embodiments;

FIG. 17 is a flow diagram of a method for doing business in accordance with the preferred embodiments; and

FIGS. 18-20 each show different portions of a detailed example of a method for doing business in accordance with the preferred embodiments.

### BEST MODE FOR CARRYING OUT THE INVENTION

The preferred embodiments provide a video e-mail server that allows efficient distribution of video e-mails. A video e-mail generation mechanism allows a video file to be created by prompting the user with a text file. The text file is used to generate a time-indexed file that includes time markers. The video e-mail generation mechanism allows the user to create a first video e-mail that specifies a list of recipients, the video file, and the time-indexed file. The first video e-mail is then sent to a video e-mail server, which parses the first video e-mail. The video file is stored in a user dataspace corresponding to the sender. The time-indexed file is used to generate a text subtitle file, which is also stored in the sender's user dataspace. A link is then generated for the video file, and a second e-mail is generated that includes the link, that preferably includes any files attached to the first video e-mail, and that specifies the recipients in the first video e-mail as recipients of the second video e-mail. When a user receives the second video e-mail, the user clicks on the link, which invokes a web page with a video player. The video file and text subtitle file are then streamed to the video player, and the video file is played while simultaneously displaying the text subtitle file as subtitles. In this manner, a text prompt file may be used by a sender to record a video file, and the same text in the text prompt file can then be displayed as subtitle text when the video file is played to a recipient.

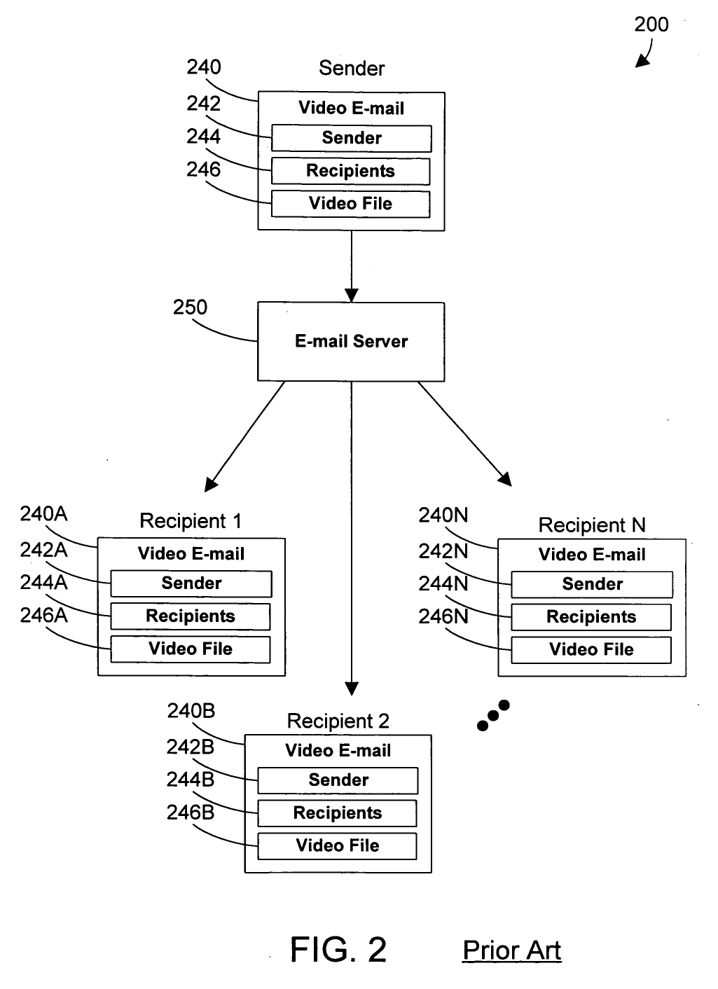

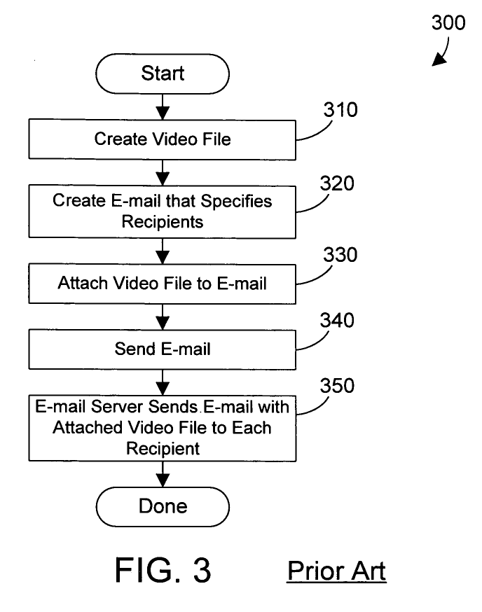

The prior art for sending video e-mails is shown in FIGS. 2 and 3. System 200 in FIG. 2 is shown from the message point of view, meaning that the corresponding hardware and software are not shown in FIG. 2. In system 200, a sender generates a video e-mail 240, which typically specifies the sender 242, the recipients 244, and a video file 246. The user then clicks on a button to send the e-mail 240, resulting in the e-mail 240 being sent to an e-mail server 250. The e-mail server 250 then replicates the e-mail, including the video file 246 (which may be quite large), and sends a copy of the video e-mail to each recipient. Thus, N recipients are shown in FIG. 2, and each recipient receives its own copy of the video e-mail. Thus, recipient 1 receives a video e-mail 240A that includes the sender 242A, recipients 244A, and video file 246A. In like manner, recipient 2 receives a video e-mail 240B that includes the sender 242B, recipients 244B, and video file 246B, as does each recipient through recipient N, who receives a video e-mail 240N that includes the sender 242N, recipients 244N, and video file 246N. The primary problem with the prior art system 200 shown in FIG. 2 is the copying of a relatively large video file 246 to each recipient, which consumes significant bandwidth and system resources.

Referring to FIG. 3, a prior art method 300 for the system 200 in FIG. 2 begins by creating a video file (step 310). Next, an e-mail may be created that specifies a list of recipients (step 320). The video file may then be attached to the e-mail (step 330). The e-mail is then sent (step 340). The e-mail server then sends the e-mail with the attached video file to each recipient (step 350). Prior art method 300 requires the e-mail server to duplicate the video file and to send the video file to each and every recipient. Thus, if the video file is 5 MB in size, and it is sent to 20 recipients, the e-mail server will have to send 100 MB to the 20 recipients.

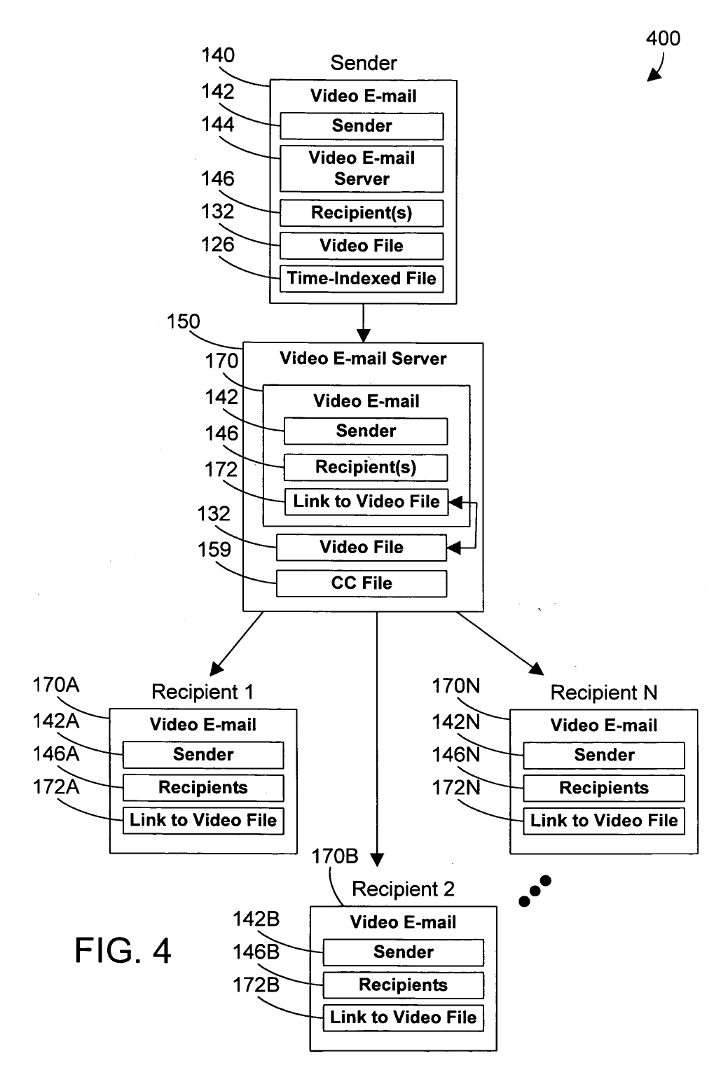

Referring to FIG. 4, a system 400 in accordance with the preferred embodiments starts with a sender defining a video e-mail 140 that preferably specifies the sender 142, a video e-mail server 144, a list of recipients 146, a video file 132, and a time-indexed file 126. The time-indexed file 126 is generated from a text file that is displayed to prompt the user while the video file is being recorded. The video e-mail 140 is then sent to a video e-mail server 150. In response, the video e-mail server 150 parses and analyzes the video e-mail 140. The video file 132 is saved to a memory in the video e-mail server 150. The time-indexed file 126 is converted into a closed caption file 159, which is also stored in the memory. A link 172 to the video file 132 is then generated. The video e-mail server 150 then generates a new video e-mail 170 that specifies the sender 142, list of recipients 146, and the link 172 to the video file 132. This new e-mail is then sent to each of the recipients in the list 146. In FIG. 4, the video e-mail 150 is sent to N recipients, represented by Recipient 1, Recipient 2, . . . , Recipient N. Recipient 1 receives a copy 170A of the video e-mail 170 that includes the sender 142A, the recipients 146A, and the link 172A to the video file. Recipient 2 receives a copy 170B of the video e-mail 170 that includes the sender 142B, the recipients 146B, and the link 172B to the video file. In like fashion, Recipient N receives a copy 170N of the vide e-mail 170 that includes the sender 142N, the recipients 146N, and the link 172N to the video file. We see from this simple example that the video file 132 is stored on the video e-mail server 150, and is not included in the video e-mails 170A-N sent to the recipients. Instead, the link 172 to the video file is sent to each recipient. When the recipient decides to view the video, the user will click on the link 172 in the video e-mail message, which will cause the video e-mail server 150 to deliver the video file 132 and the corresponding closed caption file 159 to the recipient's computer system, and will play the video file 132 while displaying the closed caption file 159, so that closed caption text corresponding to the video file 132 is displayed to the recipient as the video file 132 is played.

There are numerous advantages for the system 400 of the preferred embodiments when compared to prior art system 200 in FIG. 2. First of all, some of the recipients of the video e-mail in system 200 may decide to not view the video. When this happens, the work by the e-mail server 250 to send the entire video file to the recipient was wasted effort. In the system 400 in FIG. 4, if a recipient of the video e-mail 170 decides not to view the video, the video file is not delivered to the recipient, saving bandwidth for the video e-mail server 150. A second advantage is the timing of delivering the video file. In the prior art system 200, the video file is copied for each recipient, and the video e-mail message that includes the video file is then sent to all recipients as soon as possible. In the system 400 of the preferred embodiments, the load on the video e-mail server 150 will be distributed over time according to when the recipients open the e-mail and click on the link 172 to the video file. Even if all the recipients view the video file, the load on the video e-mail server is distributed over time, instead of having to deliver all copies of the video file to all recipients in a very short time.

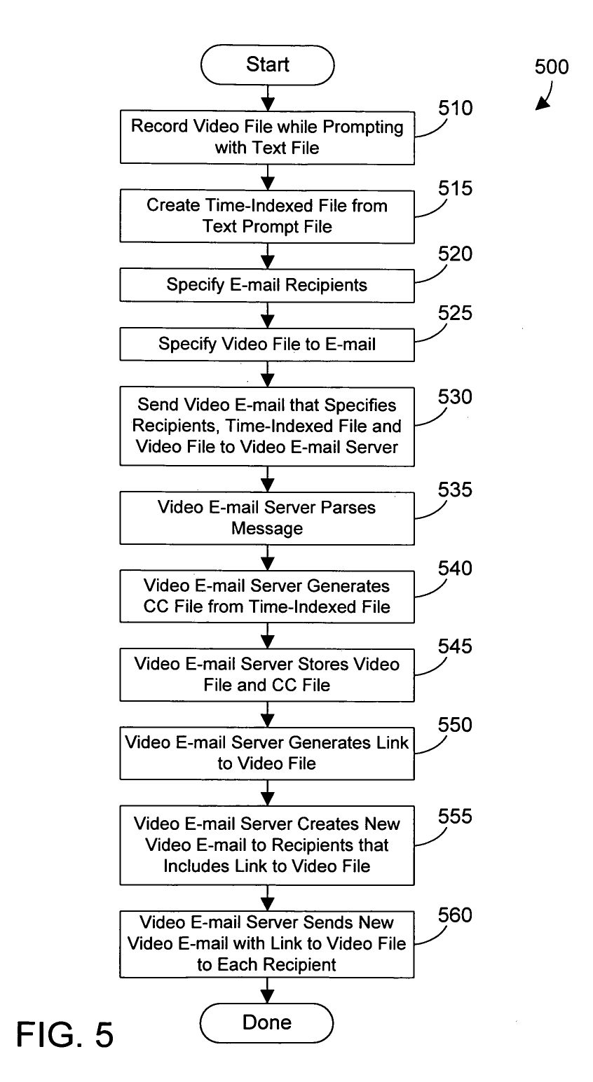

Referring to FIG. 5, a method 500 in accordance with the preferred embodiments records a video file while prompting with a text file (step 510). A time-indexed file is then created from the timed manner in which the text file was displayed as prompts to the user during the recording of the video file (step 515). The sender of the video e-mail specifies one or more recipients for the e-mail (step 520). The sender also specifies which video file to e-mail (step 525). The user then sends to a video e-mail server the video e-mail that specifies the recipients, the time-indexed file, and the video file (step 530). The video e-mail server then parses the video e-mail message (step 535). The video e-mail server generates a closed caption file from the time-indexed file (step 540). The video e-mail server then stores the video file and the closed caption file (step 545). The video e-mail server also generates a link to the video file (step 550). The video e-mail server then creates a new video e-mail to the recipients that includes the link to the video file (step 555). The video e-mail server sends the new e-mail with the link to the video file to each recipient (step 560).

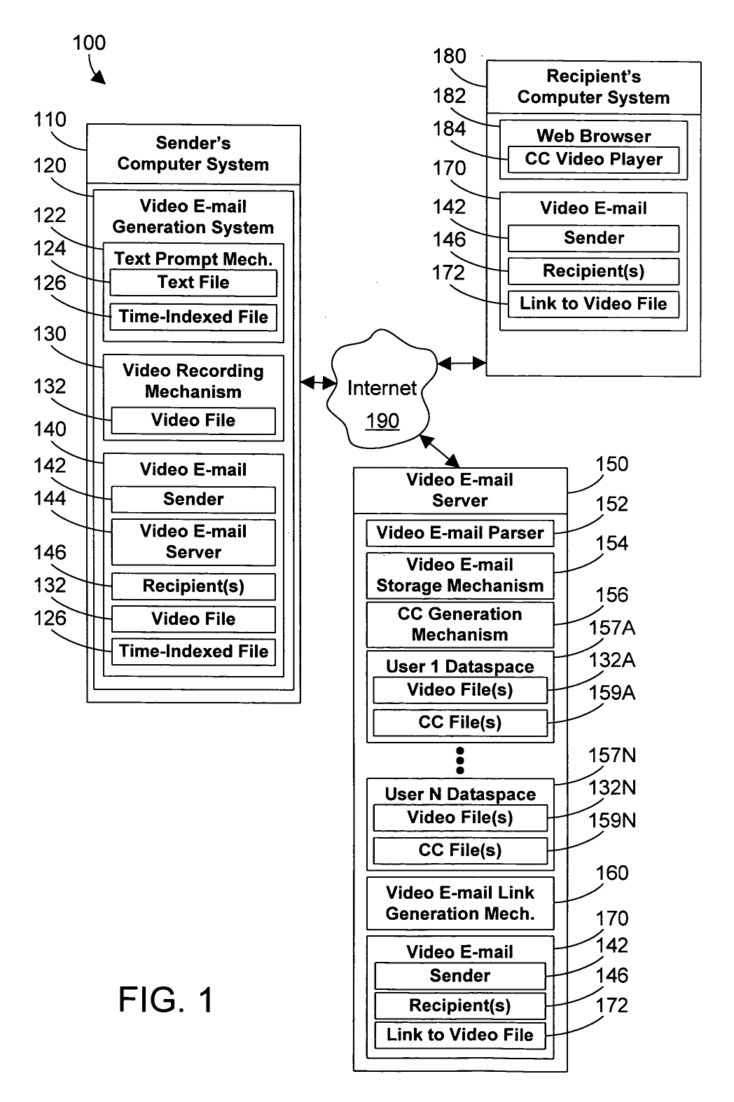

We now present a network view of the computer systems that are preferably used to implement the system 400 in FIG. 4 and method 500 in FIG. 5. Referring to FIG. 1, a networked computer system 100 is shown that includes a sender's computer system 110, a video e-mail server 150, and a recipient's computer system 180, all coupled together via a network 190, such as the Internet. The sender's computer system includes a video e-mail generation system 120, which is a software application that allows the user to generate a video e-mail that will be sent to the video e-mail server 150. The video e-mail generation system 120 includes a text prompt mechanism 122, which displays a text file 124 in a timed manner to the sender while a video file is being recorded. The text prompt mechanism 122 tracks the timed manner in which the text file 124 is displayed to the sender during the recording of a video file, and generates therefrom a time-indexed file 126. The time-indexed file 126 includes the text in the text file 124 along with time markers that determine when different portions of the text file 124 were displayed to the sender.

The video e-mail generation system 120 also includes a video recording mechanism 130 that allows recording a video file 132 at the same time the text prompt mechanism 122 is displaying the text file 124 to the sender. The video e-mail generation system 120 allows the sender to create a video e-mail 140 that specifies the sender 142, the video e-mail server 144, a list of recipients 146, the video file 132, and the time-indexed file 126. The sender then clicks on a button to send the video e-mail 140, which causes the video e-mail 140 to be sent to the video e-mail server 150. In the preferred embodiments, the e-mail 140 is not sent to the recipients 146, but is only sent to the video e-mail server 150 via network 190.

When the video e-mail server 150 receives the video e-mail 140, a video e-mail parser 152 parses the video e-mail 140 to determine its contents. A video e-mail storage mechanism 154 stores the video file 132 to memory within the video e-mail server. A closed caption generation mechanism 156 reads the time-indexed file 126 from the incoming video e-mail 140, and generates therefrom a corresponding closed caption file. In the most preferred implementation, each user has a defined dataspace, and the video file in the incoming message is stored in the user dataspace corresponding to the sender. FIG. 1 shows N user dataspaces, with a first dataspace 157A corresponding to a first user, with one or more video files 132A and corresponding closed caption files 159A, and an Nth dataspace 157N corresponding to an Nth user, with one or more video files 132N and corresponding closed caption files 159N. The video e-mail server storage mechanism 154 stores the video file 132 to the sender's dataspace, and the closed caption generation mechanism 156 also stores the corresponding closed caption file to the sender's dataspace. A video e-mail link generation mechanism 160 generates a link to the video file in the sender's dataspace. The video e-mail server 150 then creates a new video e-mail 170 that specifies the sender 142, recipients 146, and the link 172 to the video file. This new video e-mail 170 is sent to all recipients in the list of recipients 146 via network 190.

The recipient's computer system 180 represents a computer system of any of the recipients in the recipient list 146. The recipient's computer system 180 receives the newly-generated video e-mail 170 that specifies the sender 142, recipients 146, and link 172. When the user clicks on the link 172, a web page is displayed in a web browser 182 that includes a closed-caption video player 184. The closed caption video player 184 streams in the video file 132 and the corresponding closed caption file 159, allowing the video to be played with closed caption text that was generated from the original text file used to prompt the sender. In this manner, closed caption videos may be easily created and distributed without the labor of separately generating closed caption text. The closed caption file is generated automatically from the text file that was used to prompt the sender, thereby automatically maintaining complete integrity between the prompt text and the closed caption text.

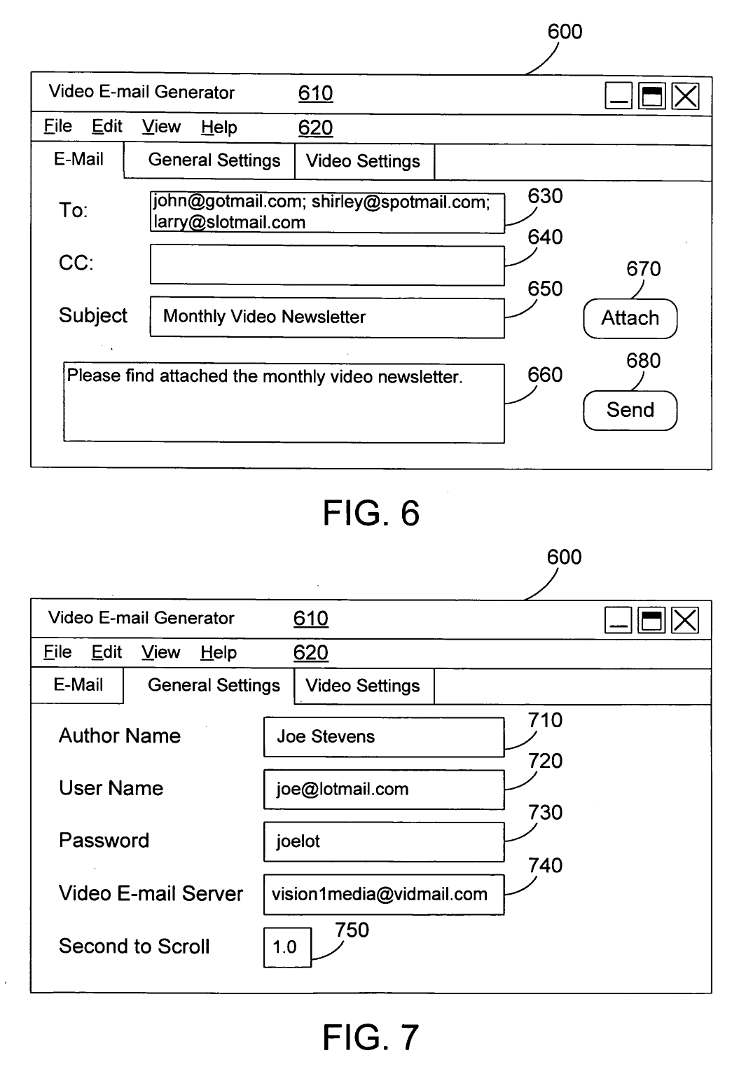

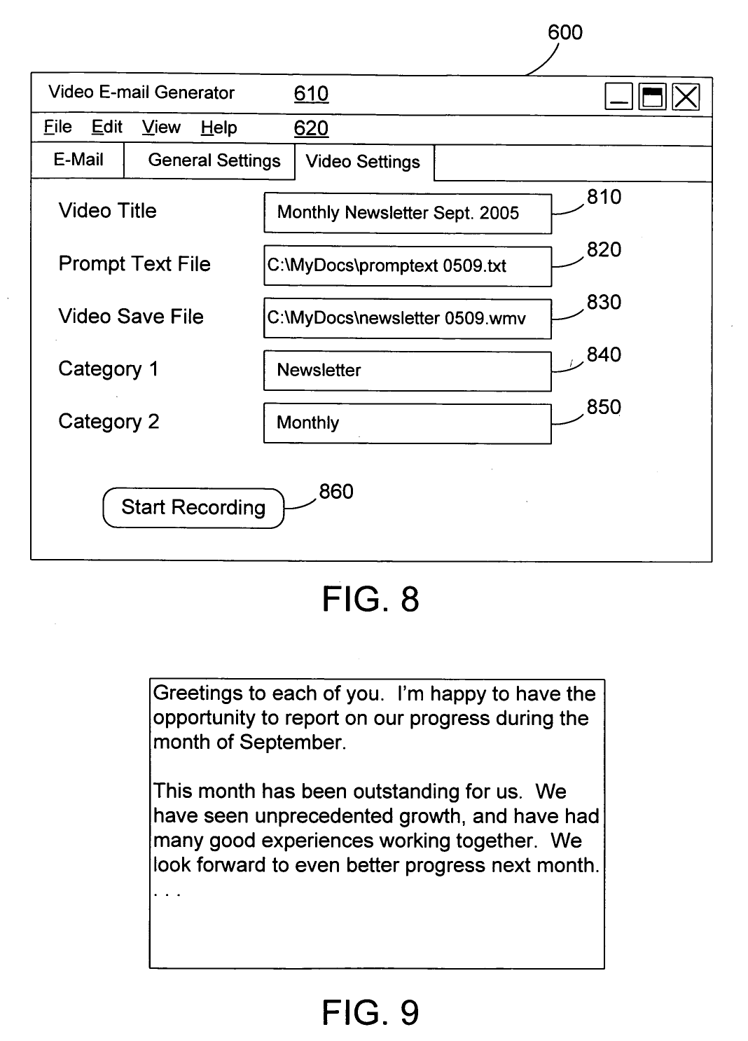

An example is now presented to illustrate one suitable implementation of the video e-mail system of the preferred embodiments. Referring to FIG. 6, a display window 600 is displayed in the video e-mail generation system 120 of FIG. 1 to allow a sender to define and send a video e-mail. The display window 600 includes a title bar 610 that shows this is the video e-mail generator display window, and a menu bar 620 that allows the sender to invoke various menu functions. The display includes three tabs, an E-mail tab that is displayed in FIG. 6, a General Settings tab that is displayed in FIG. 7, and a Video Settings tab that is displayed in FIG. 8. In the E-mail tab shown in FIG. 6, the sender specifies the list of recipients in the To: field 630. We assume for this example the user specifies three recipients, namely john@gotmail.com, shirley@spotmail.com, and larry@slotmail.com. The E-mail tab also includes a Cc: field 640 which can list additional recipients. A Subject field 650 allows the sender to put in a short text message that indicates the subject of the e-mail message. A main text field 660 allows the sender to include text that will be in the main body of the e-mail message. An Attach button 670, when clicked by the sender, brings up a directory listing that allows the sender to select one or more files to attach to the e-mail message. A Send button 680 is clicked by the sender once the e-mail message is ready to send. Note that the send button 680 would generally not be pressed until the sender specifies the appropriate information in the General Settings tab shown in FIG. 7 and in the Video Settings tab shown in FIG. 8.

The General Settings tab is shown in FIG. 7 to include the name of the sender in an Author Name field 710. We assume the sender is named Joe Stevens for this example. A User Name field 720 allows the sender to enter a user ID that uniquely identifies the sender to the video e-mail server 150. In the embodiments illustrated herein, the sender's e-mail address joe@lotmail.com is used as a User Name for the video e-mail server 152, which is simple because the User Name then also specifies the sender 142 in the video e-mail message. Of course, the User Name could be something different than the user's e-mail address, but this would then require the sender to separately indicate his or her e-mail address in a different field to specify the sender 142 in the video e-mail 140. A password field 730 is included that allows the sender to enter a password that is needed to access the video e-mail server 150. The Video E-mail Server field 740 specifies a web address corresponding to the video e-mail server 150. In this example, the video e-mail server has a web address of vision1media@vidmail.com. The Second to Scroll field 750 allows the sender to specify how many seconds to highlight a line of text prompt before highlighting the next line. In the example in FIG. 7, the sender has entered 1.0, meaning that each line of text from the text file 124 will be highlighted for 1.0 seconds before highlighting the next line of text.

The Video Settings tab is shown in FIG. 8 to include a Video Title field 810 that is used to specify the text title of the video that will be created. A Prompt Text File field 820 specifies a directory path to a text file that will be used to prompt the sender while the video is being recorded. In this example, the text file is promptext 0509.txt in the directory C:\MyDocs. While the text file is assumed to be in simple text format, the text file could also be in any suitable format, including wordprocessor format, spreadsheet format, etc. In short, any suitable format may be used for the text file. A Video Save File field 830 specifies a directory path to a filename of the video file that will be created when recording starts. In this example, the video file will have the name newsletter 0509.wmv in the C:\MyDocs directory. The specific example shown in FIG. 8 also shows two category fields 840 and 850 that allow the sender to enter key words that may be used to categorize the video file for future searching. A Start Recording button 860 is clicked by the sender when the sender is ready for the video to start recording. In the preferred embodiments, the sender's computer system is equipped with a webcam that may be mounted on or near the sender's monitor, thereby allowing the text prompt window to be displayed close to the webcam to make it appear the sender is looking into the camera instead of reading text prompts.

We assume for this example that the file at C:\MyDocs\promptext 0509.txt is shown in FIG. 9. This is a simple text file. Note that the sender preferably inserts line breaks to define lines of text in the text file.

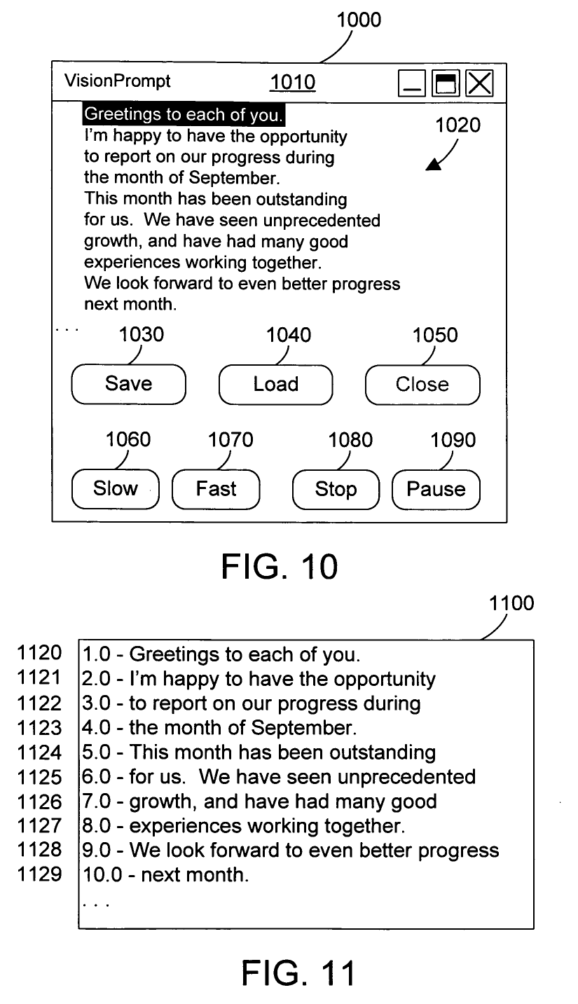

We now assume the user clicks on the Start Recording button 860. As a result, a VisionPrompt window 1000 is displayed as shown in FIG. 10. The VisionPrompt window includes a title bar 1010, and a display of the text file shown in FIG. 9 in a timed manner. The timed manner is accomplished by highlighting each line of text, one at a time, with reverse video, color, or any other suitable means of differentiating a selected line of text from other, non-selected lines of text. As shown in FIG. 10, the first line in the timed display 1020 is highlighted first. After 1.0 seconds, the highlight will move to the second line of text. After 2.0 second, the highlight will move to the third line of text, and so on, thereby presenting the prompt text from the specified text file to the user in a timed manner. Note that a Slow button 1060 and a Fast button 1070 are provided for the user to dynamically vary the speed of displaying the prompt text in the timed display 1020. For example, if the sender is having a hard time speaking the lines of text before the highlights moves to the next line, the user can click on the Slow button 1060 to slow the scroll rate. If the sender is speaking the lines of text faster than the highlight moves to the next line, the sender can click on the Fast button 1070 to increase the scroll rate. Note that the Slow and Fast buttons 1060 and 1070, respectively, may alter the scroll rate by any suitable increment. For example, these buttons could alter the scroll rate by increments of 0.2 seconds each time the button is pressed, thereby allowing the user to find a suitable scroll rate for the time display 1020. A Stop button 1080 is clicked by the user when the video recording is complete. A Pause button 1090 is clicked by the user to pause recording. In the preferred embodiments, the Pause button 1090, when clicked to pause recording, then shows “Resume” so the sender can continue recording after the pause. The Save button 1030 is clicked by the sender after the video is recorded and the sender is satisfied with the recording. The Load button 1040 may be clicked by the sender to load and play a video that has already been recorded, allowing the sender to review a video before sending it. The Close button 1050 is showed grayed out, which means this button cannot be selected until the recording of the video is stopped. Once the user clicks on the Stop button 1080, the Close button 1050 turns black, thereby allowing the user to select the Close button 1050 to close the VisionPrompt window 1000 once the video has been recorded and saved.

Displaying the text file in a timed manner allows the creation of a time-indexed file 1100, as shown in FIG. 11. We assume for this simple example that the sender did not alter the scroll speed of 1.0 second specified at 750 in FIG. 7 by clicking on the Slow 1060 or Fast 1070 buttons. Each line in the time-indexed file 1100 includes a time marker that indicates the relative time from the start of the video recording that each line of text was displayed to the sender. The time markers are shown at the left edge of the time-indexed file 1100 in FIG. 11. Thus, the line “Greetings to each of you.” has a time marker of 1.0, representing 1.0 seconds. The line “I'm happy to have the opportunity” has a time marker of 2.0. In similar fashion, each of the remaining lines also have corresponding time markers. Thus, each line 1120-1129 shown in FIG. 11 in the time-indexed file has a corresponding time marker that represents a time index from the beginning of the video file when the line of text was displayed.

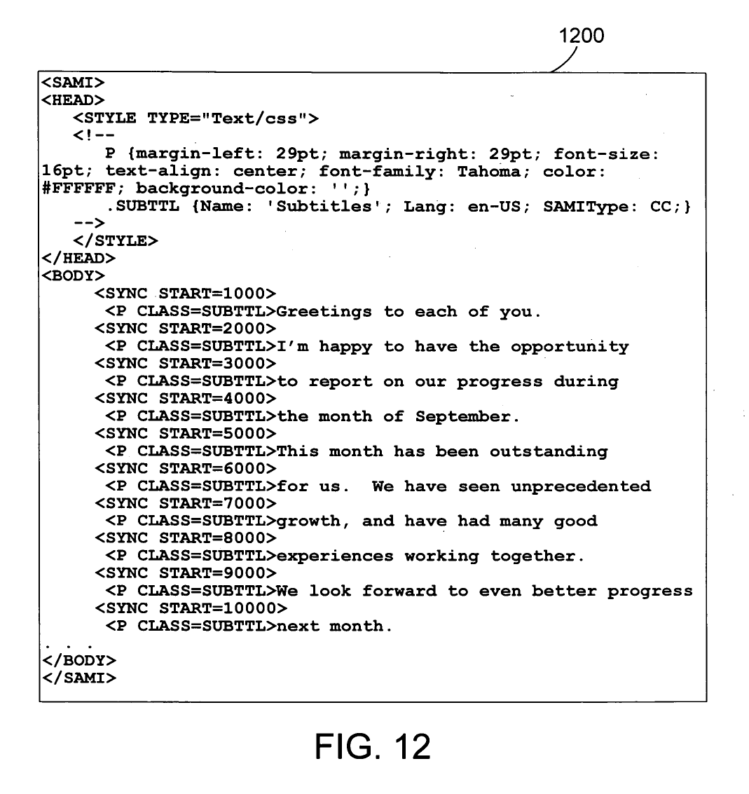

As stated above with respect to FIG. 1, the closed caption generation mechanism 156 in the video e-mail server 150 reads a time-indexed file 126, and generates therefrom a corresponding closed caption file 159. This is shown in step 540 in FIG. 5. Referring to FIG. 12, a sample closed caption file 1200 is shown for the time-indexed file 1100 shown in FIG. 11. The closed caption file 1200 is in an HTML-type format, with a header defined between the tags <HEAD> and </HEAD>, and a body that includes the prompt text and time marker information between the tags <BODY> and </BODY>. Note that the time marker information in the time-indexed file 1100 is encapsulated within a SYNC START tag that specifies the value of the time marker. The text for each line follows a SUBTTL tag that identifies the text as a subtitle line. While the closed caption file 1200 may have any suitable format, the format shown in FIG. 12 is compatible with the closed captioning capabilities of Microsoft Internet Explorer at the time this patent application was filed.

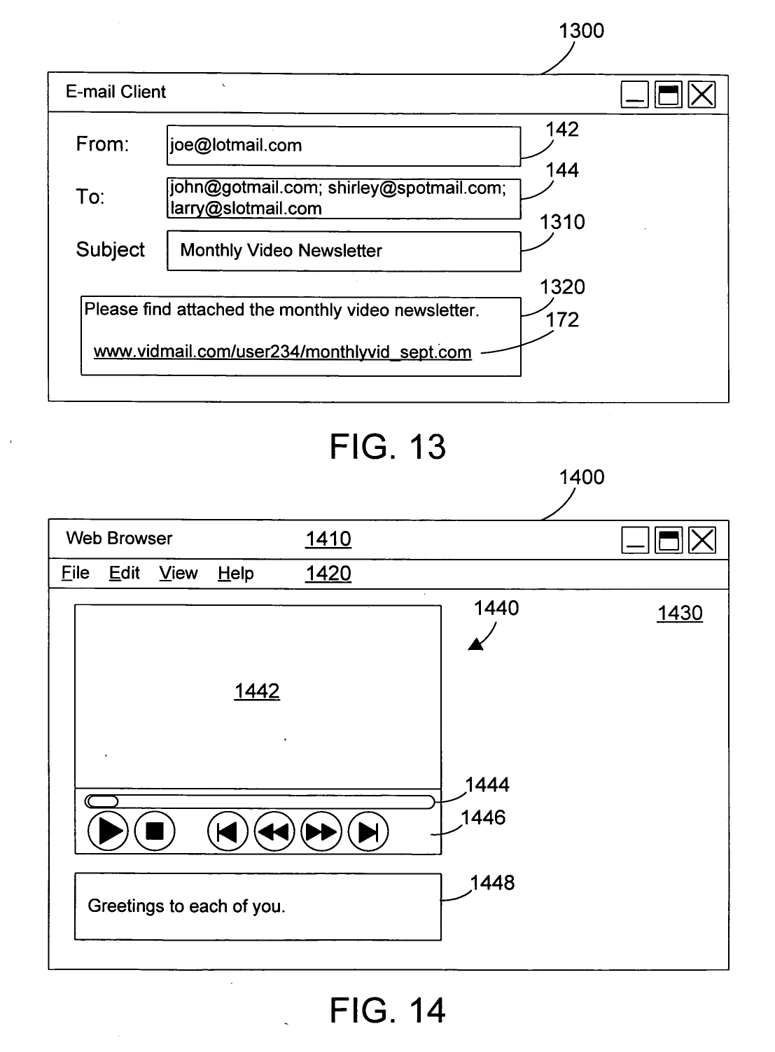

Referring now to FIG. 13, a display window 1300 represents a display window in a traditional e-mail client that is used by a recipient of the new video e-mail 170. The video e-mail sent to the recipient specifies the sender 142 in a From: field, specifies the recipients 144 in the To: field, includes the subject line 1310 that was originally created by the sender, includes the text in the body 1320 that was originally created by the sender, and includes a link 172 to the video file stored on the video e-mail server. While the link 172 is shown in the text body 1320 of the e-mail, it is equally within the scope of the preferred embodiments to include the link as an attachment or in any other suitable location associated with the e-mail.

When the recipient clicks on the link 172 in FIG. 13, a web browser window 1400 is launched, as shown in FIG. 14. The web browser window 1400 may include a title bar 1410 and menu bar 1420. Web browser window 1400 includes a main display area 1430. In the preferred embodiments, clicking on the link 172 invokes a software application that invokes a video player, and specifies to the video player the video file on the video e-mail server and the corresponding closed caption file on the video e-mail server. As a result, the video player 1440 is displayed, with the video file being played on the main viewer window 1442 while corresponding closed caption text is displayed in the closed caption window 1448. Note that the video player display 1440 includes a horizontal scroll bar 1444 that indicates the progress in playing the video file, and buttons at 1446 that may be used to play, stop, pause, jump to beginning, rewind, fast-forward, and jump to end of the video file, as is known in the art with video players. Note that Microsoft Media Player currently has the capability of displaying closed caption text for a video file by simply passing the video player a video file and the corresponding closed caption file.

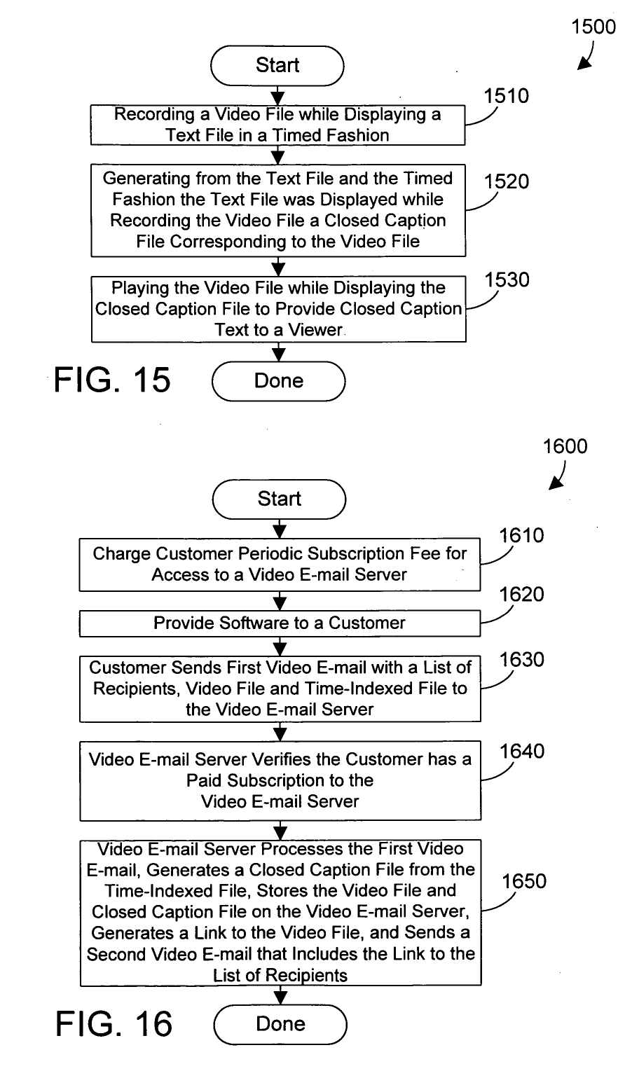

One of the significant features of the present invention is the automatic generation of closed caption text from text that was originally used to prompt the sender when the video was initially recorded. None of the known systems provide this type of automatic end-to-end functionality that prompts the sender with text in a timed manner, and provides the same text as closed captions in the same timed manner when the video is played. Referring to FIG. 15, a method in accordance with the preferred embodiments begins by recording a video file while displaying a text file in a timed fashion (step 1510). A corresponding closed caption file is then generated from the text file and the timed fashion it was displayed while recording the video file (step 1520). The video file is then played while displaying the closed caption file to provide closed caption text to a viewer (step 1530). Method 1500 thus illustrates the end-to-end system, where the text file and timed manner it was displayed automatically creates the closed caption file that is used when the video is played.

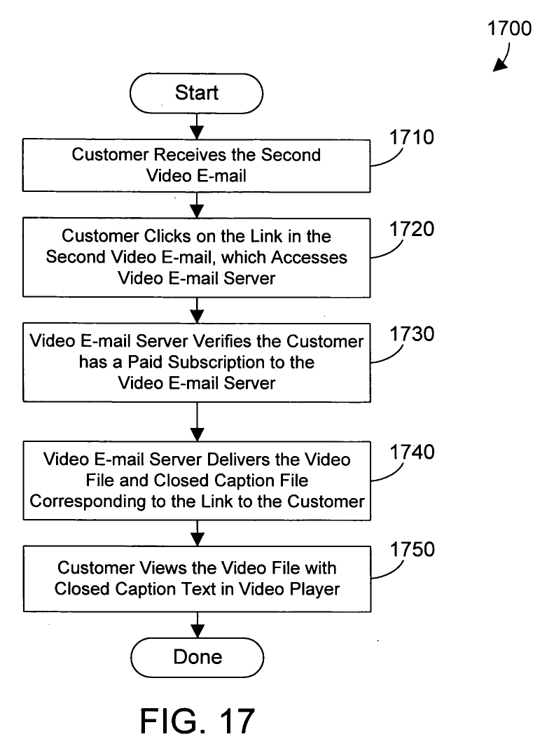

Various methods of doing business are within the scope of the preferred embodiments. Method 1600 in FIG. 16 shows steps performed for a video e-mail server to send a video e-mail that includes a link to a video file to listed recipients. Method 1700 in FIG. 17 shows steps performed by a recipient to view the video corresponding to the link in the received e-mail. Referring to FIG. 16, a customer is charged a periodic subscription fee for access to the video e-mail server (step 1610). For example, the customer could be charged a monthly fee. Software is then provided to the customer (step 1620). One suitable example of software that could be provided to the customer in step 1620 is video e-mail generation system 120 shown in FIG. 1. The customer then sends a first video e-mail with a list of recipients, a video file, and a time-indexed file to the video e-mail server (step 1630). Note that the list of recipients may include one or many recipients. The video e-mail server verifies the customer has a paid subscription to the video e-mail server (step 1640). Once the sender's paid status is verified in step 1640, the video e-mail server processes the first video e-mail, generates a closed caption file from the time-indexed file, stores the video file and closed caption file on the video e-mail server, generates a link to the video file, and sends a second video e-mail that includes the link to the list of recipients (step 1650).

Method 1700 in FIG. 7 begins when a recipient, who is also a customer, receives the second video e-mail (step 1710) that was sent in step 1650 of FIG. 16. The customer clicks on the link in the second video e-mail, which accesses the video e-mail server (step 1720). The video e-mail server verifies the customer has a paid subscription to the video e-mail server (step 1730). The video e-mail server delivers the video file and closed caption file corresponding to the link to the customer (step 1740). The customer then views the video file with the closed caption text using a video player (step 1750).

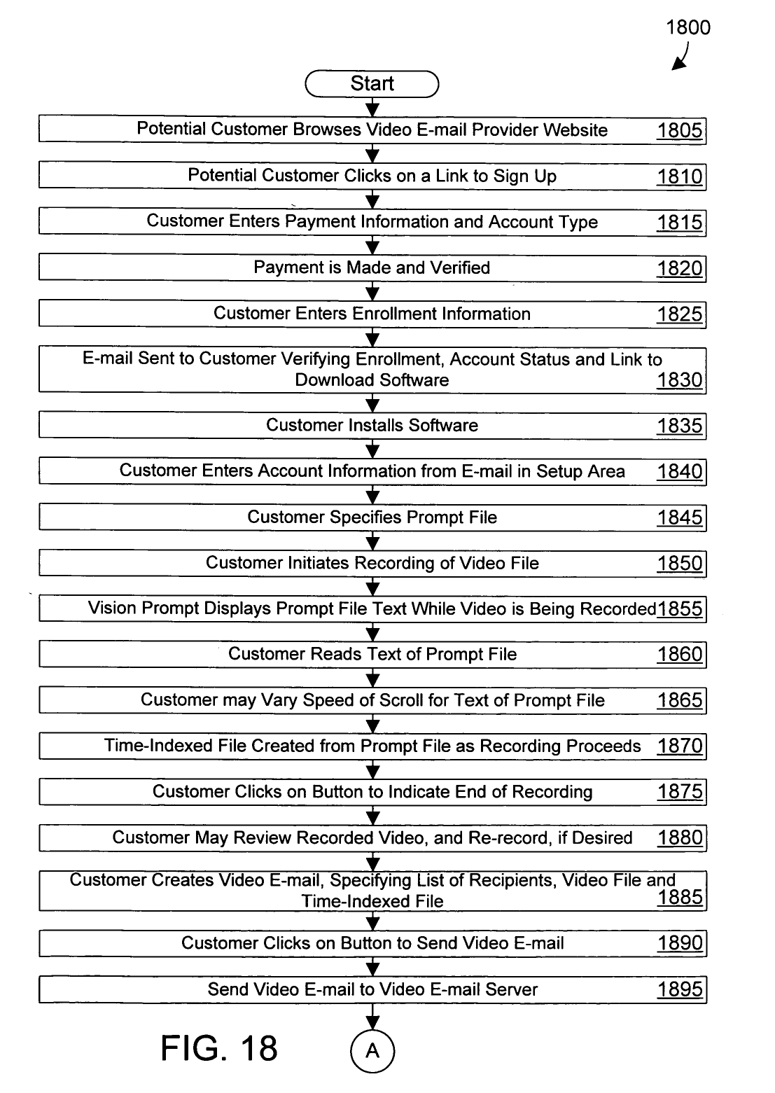

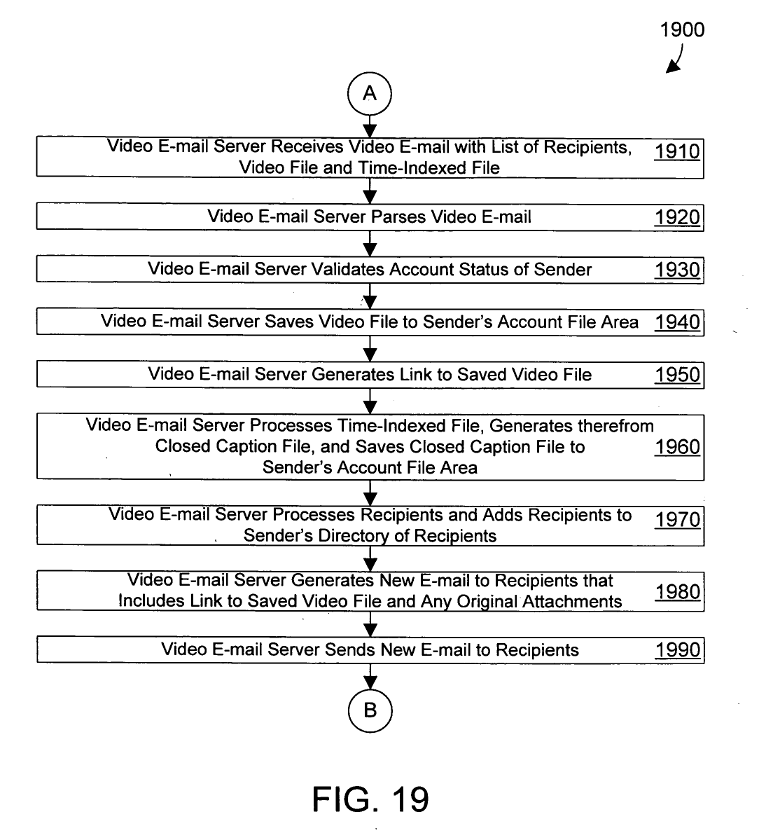

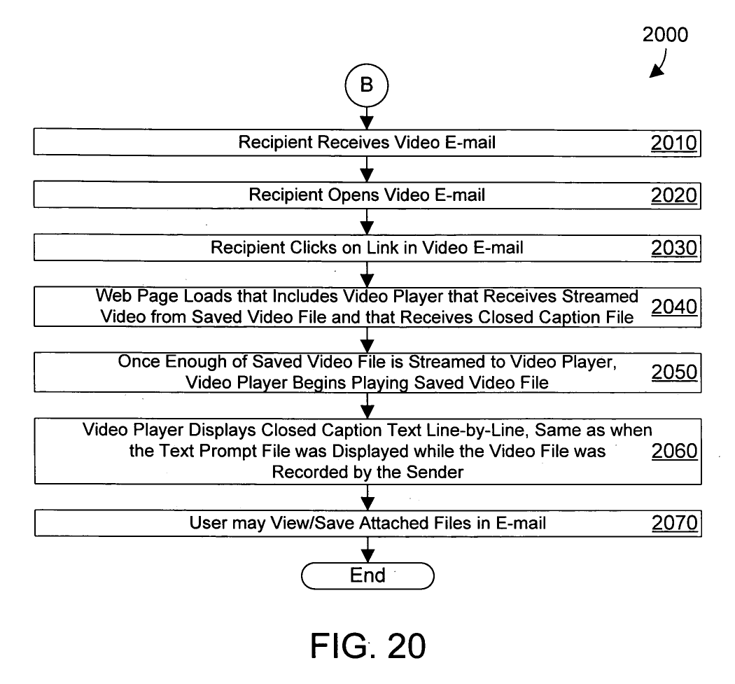

A more detailed method of doing business in accordance with the preferred embodiments is shown in FIGS. 18-20. Method 1800 in FIG. 18 shows the steps for creating a first video e-mail and sending the first video e-mail to a video e-mail server. Method 1900 in FIG. 19 shows the steps the video e-mail server performs to send a new e-mail derived from the first e-mail to a list of recipients. Method 2000 in FIG. 20 steps performed by a recipient of the new e-mail. Referring to FIG. 18, method 1800 begins when a potential customer browses the video e-mail provider's website (step 1805). If the potential customer decides to sign up, the potential customer clicks on a link to sign up (step 1810). The customer then enters payment information and account information, including the account type (step 1815). Next, payment is made and verified (step 1820). Once payment is verified, the customer enters enrollment information (step 1825). Enrollment information may include, for example, a username and password for the customer to access a video e-mail server. An e-mail is then sent to the customer verifying enrollment and account status, and providing a link to download the client software (step 1830). The video e-mail generation system 120 is one suitable example of the client software. Of course, it is equally within the scope of the preferred embodiments to send the client software to the customer, e.g., via a mailed CD-ROM. The customer then installs the software (step 1835). The customer then executes the software, and enters account information from the e-mail the customer received in step 1830 in the setup area (step 1840). The customer then specifies a prompt file to use when recording a video (step 1845). The customer then initiates recording of the video file (step 1850). The vision prompt displays the prompt file text in a timed manner while the video is being recorded (step 1855). The customer then reads the text of the prompt file (step 1860) as the video is being recorded. The customer may vary the speed of scroll for the text of the prompt file (step 1865). A time-indexed file is created from the prompt file as recording proceeds (step 1870). The customer then clicks on a button in indicate the end of recording (step 1875). The customer may review the recorded video, and re-record, if desired (step 1880). The customer then creates a video e-mail, specifying a list of recipients, the video file, and the time-indexed file (step 1885). The customer then clicks on a button to save the video e-mail (step 1890). The video e-mail is then sent to the video e-mail server (step 1895).

Once the video e-mail is sent to the video e-mail server in step 1985, the video e-mail server performs the steps in method 1900 shown in FIG. 19. The video e-mail server receives the video e-mail with the list of recipients, the video file, and the time-indexed file (step 1910). The video e-mail server then parses the video e-mail (step 1920). The video e-mail server validates the account status of the sender (step 1930) to verify that the sender is a customer with a paid subscription. The video e-mail server saves the video file to the sender's account file area (step 1940). In the preferred embodiments, the video e-mail server includes customer dataspaces in memory, and each customer preferably has a different dataspace in memory. The video e-mail server then generates a link to the saved video file (step 1950). The video e-mail server processes the time-indexed file, generates therefrom a closed caption file, and saves the closed caption file to the sender's account file area (step 1960). The video e-mail server then processes the list of recipients, and adds the e-mail addresses of the recipients to the sender's directory of recipients on the video e-mail server (step 1970). The video e-mail server then generates a new e-mail to the recipients specified in the e-mail received in step 1910 that includes a link to the saved video file and any original attachments (step 1980). The video e-mail server then sends the new e-mail to each recipient (step 1990). Once the new e-mail is sent to all recipients, the steps of method 2000 shown in FIG. 20 may be performed.

First, the recipient receives the new video e-mail sent in step 1990 in FIG. 19 (step 2010). The recipient opens the video e-mail (step 2020). The recipient clicks on the link in the video e-mail (step 2030). In response to clicking the link, a web page loads in a web browser that includes a video player that receives streamed video from the saved video file on the video e-mail server and that receives the closed caption file from the video e-mail server (step 2040). Once enough of the saved video file is streamed to the video player, the video player begins playing the saved video file (step 2050). Of course, the entire video file and closed caption file could also be downloaded before playing the video, rather than streaming the video and closed caption file. The video player displays closed caption text line-by-line, the same as when the text prompt file was displayed while the video file was recorded by the sender (step 2060). The user may view or save the attached files in the e-mail (step 2070), preferably when playback of the video is paused or has ended.

Note that the method for doing business shown in FIGS. 18-20 includes many detailed steps that show the best mode of the invention. Note, however, that many variations could be made within the scope of the preferred embodiments. For example, a time-indexed file is created on the sender's computer system in step 1870, and is sent with the video e-mail to the video e-mail server in step 1895. The video e-mail server then uses the time-indexed file to generate a closed caption file in step 1960 in FIG. 19. Performing the conversion from the time-indexed file to the closed caption file is preferably done by the video e-mail server because the standards for closed caption files continue to evolve and change. By placing the conversion on the video e-mail server, any change to the closed caption file definition may be addressed by upgrading the software running on the video e-mail server without the need to upgrade the client software. Of course, it is also within the scope of the preferred embodiments to generate the closed caption file in the sender's computer system and send the video file and closed caption file to the video e-mail server. However, this arrangement requires an update of each client software each time the closed caption file format changes. For this reason, the most preferred implementation generates the closed caption file in the video e-mail server.

Other variations are also within the scope of the preferred embodiments. For example, once the new video e-mail has been sent to the recipients, either the sender or the recipients could access the video file on the video e-mail server. In addition, the sender, for an additional fee, could add custom banner ads that will be viewed along with the video. The ads could be maintained from a maintenance window available on the video e-mail server. The sender could sent out view-only links to a directory listing of video files on the video e-mail server so other can view these files without the ability to change them. These and other variations are within the scope of the preferred embodiments.

Note that the specific examples herein refer to closed caption files, and the display of closed caption text. Note, however, that the term “closed caption” is used broadly herein to include any suitable way of displaying text subtitles for a video. The term “closed caption” should not be construed as limiting to any particular technology or format for displaying text subtitles for a video. The preferred embodiments expressly extend to any and all mechanisms and methods for displaying text subtitles, whether currently known or developed in the future.

The video e-mail system described herein may be used in a variety of different ways. For example, a church could subscribe as a customer, which would allow the pastor to provide daily, monthly or weekly video messages to the church members. A school, club, or business could also use the video e-mail system of the present invention to disseminate video information to its students, members, or employees, respectively. Note that the fee structure may be customized depending upon the user and application. For example, a church might be charged a monthly fee that is based on the number of video e-mails viewed, while the church members would be charged a nominal monthly fee to access the video e-mails. There are many possible variations in usage and pricing that are all within the scope of the preferred embodiments.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A networked computer system comprising:
(A) a first computer system comprising:
a video e-mail generation system comprising:
a video recording mechanism for recording a video file;
a first video e-mail that specifies a plurality of recipients and the video file;
wherein the video e-mail generation system sends the first video e-mail to a video e-mail server in a second computer system coupled via a network to the first computer system;
(B) the second computer system comprising:
the video e-mail server comprising:
a video e-mail parser that parses the first video e-mail;
a video e-mail storage mechanism that stores the video file in a memory;
a video e-mail link generation mechanism that creates a link to the stored video file;
a second video e-mail that the video e-mail server generates from the first video e-mail, the second video email specifying the plurality of recipients and the link to the stored video file;
wherein the video e-mail server sends the second video e-mail to the plurality of recipients.

2. The networked computer system of claim 1 wherein the video e-mail generation system further comprises a text prompt mechanism that displays a text file in a timed fashion, wherein the video recording mechanism records the video file while the text prompt mechanism displays the text file, and wherein the video e-mail generation system generates a time-indexed file from the text file and the timed fashion in which the text prompt mechanism displayed the text file.

3. The networked computer system of claim 2 wherein the text prompt mechanism comprises a mechanism to vary speed of highlighting or displaying portions of the text file.

4. The networked computer system of claim 2 wherein the video e-mail generation system further comprises a text subtitle mechanism that generates from the text file a text subtitle file, wherein the video e-mail storage mechanism stores the text subtitle file in the memory.

5. The networked computer system of claim 1 wherein the link, when selected by a user, causes the video file and a corresponding text subtitle file to be delivered to the user.

6. The networked computer system of claim 1 wherein the memory comprises a plurality of user dataspaces, and wherein the video file is stored in a user dataspace corresponding to a user that created the first video e-mail.

7. A networked computer system comprising:
a first computer system comprising:
a video e-mail generation system comprising:
a text prompt mechanism that displays a text file in a timed fashion;
a video recording mechanism for recording a video file while the text prompt mechanism displays the text in a timed fashion;
a mechanism that generates a time-indexed file from the text file and the timed fashion in which the text prompt mechanism displayed the text file;
a first video e-mail that specifies a plurality of recipients, the video file, and the time-indexed file;
a second computer system coupled via a network to the first computer system, the second computer system comprising:
a video e-mail server comprising:
a video e-mail parser that parses the first video e-mail;
a video e-mail storage mechanism that stores the video file in a memory;
a text subtitle mechanism that generates from the time-indexed file a text subtitle file;
a video e-mail link generation mechanism that creates a link to the stored video file;
a second video e-mail that specifies the plurality of recipients and the link to the stored video file;
wherein the video e-mail server sends the second video e-mail to the plurality of recipients.

8. A networked computer system comprising:
a first computer system comprising:
a video e-mail generation system comprising:
a text prompt mechanism that displays a text file in a timed fashion;
a video recording mechanism for recording a video file while the text prompt mechanism displays the text in a timed fashion;
a first video e-mail that specifies a plurality of recipients, the video file, and the a text subtitle file generated from the text file and the timed fashion in which the text prompt mechanism displayed the text file;
a second computer system coupled via a network to the first computer system, the second computer system comprising:
an e-mail client that receives the first video e-mail from the first computer system; and
a video player that plays the video file and displays the text subtitle file while the video file is being played to provide text subtitle text to a viewer.

9. A computer-implemented method for sending a video e-mail to a plurality of recipients, the method comprising the steps of:
generating a video file;
generating a first e-mail message that specifies a plurality of recipients and the video file;
sending the first e-mail message to a video e-mail server;
the video e-mail server parsing the first e-mail message;
the video e-mail server storing the video file in a memory;
the video e-mail server creating a link to the video file stored in the memory;
the video e-mail server creating from the first e-mail message a second e-mail message that includes the link to the video file stored in the memory; and
the video e-mail server sending the second e-mail message to the plurality of recipients specified in the first e-mail message.

10. The method of claim 9 further comprising the step of displaying a text file in a timed fashion during the step of generating the video file.

11. The method of claim 10 further comprising the step of providing controls to a user that allow the user to vary speed of highlighting or displaying portions of the text file.

12. The method of claim 10 further comprising the steps of:
generating from the text file a text subtitle file;
sending the text subtitle file in the first e-mail; and
the video e-mail server storing the text subtitle file in the memory.

13. The method of claim 9 wherein the link, when selected by a user, causes the video file and a corresponding text subtitle file to be delivered to the user.

14. The method of claim 9 wherein the memory comprises a plurality of user dataspaces, and wherein the video file is stored in a user dataspace corresponding to a user that created the first video e-mail.

15. A computer-implemented method for playing a video file, the method comprising the steps of:
(A) recording a video file while displaying a text file in a timed fashion;
(B) generating from the text file and the timed fashion the text file was displayed while recording the video file a text subtitle file corresponding to the video file; and
(C) playing the video file and displaying the text subtitle file while the video file is being played to provide subtitle text to a viewer.

16. The method of claim 15 wherein the video file and text subtitle file are sent in an e-mail, and step (C) is performed when a user selects to play the video file in the e-mail.

17. A method for doing business, the method comprising the steps of:
(A) providing video e-mail generation software to a customer, the video e-mail generation software comprising:
a video recording mechanism for recording a video file;
a video e-mail generation mechanism that allows the customer to create a first video e-mail that specifies a plurality of recipients and the video file;
(B) the video e-mail generation software sending the first video e-mail to a video e-mail server;
(C) providing the video e-mail server that receives the first video e-mail from the user, the video e-mail server comprising:
a video e-mail parser that parses the first video e-mail;
a video e-mail storage mechanism that stores the video file in a memory;
a video e-mail link generation mechanism that creates a link to the stored video file;
a second video e-mail that the video e-mail server generates from the first video e-mail, the second video email specifying the plurality of recipients and the link to the stored video file;
(D) the video e-mail server sending the second video e-mail to the plurality of recipients.

18. The method of claim 17 wherein step (A) is performed after the customer signs up to access the video e-mail server and pays a corresponding fee.

19. The method of claim 17 wherein steps (C) and (D) are performed for the customer in exchange for the customer paying a subscription fee for a predetermined period of time.

20. The method of claim 17 further comprising the steps of:
one of the plurality of recipients receiving the second video e-mail;
the one recipient selecting the link to the stored video file in the second video e-mail;
the video e-mail server verifying the customer has a paid subscription to the video e-mail server;
the video e-mail server delivering the stored video file and a corresponding subtitle text file to a video player; and
the video player displaying the video file with text subtitles to the one recipient.
